(19) United States
(12) Patent Application Publication
(10) Pub. No.: US 2015/0248626 A1
(43) Pub. Date: Sep. 3, 2015

(54) DIGITAL TICKET ISSUANCE, EXCHANGE AND VALIDATION SYSTEMS AND METHODS

(71) Applicant: IntelliSysGroup LLC, Cambridge, MA (US)

(72) Inventors: Lawrence S. Rogel, Brookline, MA (US); Jason J. Ossenmacher, Balboa Island, CA (US)

(21) Appl. No.: 14/688,707

(22) Filed: Apr. 16, 2015

Related U.S. Application Data
(63) Continuation of application No. 13/328,885, filed on Dec. 16, 2011.

(51) Int. Cl. G06Q 10/02; H04L 29/08

(52) U.S. Cl. CPC G06Q 10/02; H04L 67/32

(57) ABSTRACT

The invention provides, in some aspects, a digital ticketing system, comprising first and second digital data devices (e.g., cell phones, PDAs, etc.) that are coupled, at least intermittently, with a server via a network. The server responds to a request, e.g., from the first digital data device, by electronically issuing to it a ticket (or option therefor) for use by a holder thereof in gaining a seating (or other selected attendance) at an event. The server responds to a subsequent request, e.g., by the second digital data device, by (re)issuing the ticket (and/or option) to it for use by a holder of that second device in gaining the aforesaid seating (or other selected attendance) at the event in lieu of that by the holder of the first digital data device.

### BACKGROUND OF THE INVENTION

The invention pertains to electronic ticketing and, more particularly, to systems and methods of electronic ticketing for sports, music and other events.

Electronic ticketing has been in the common parlance since the mid-1990s, when it was adopted by the airline industry as a then-emerging means for the delivery of airline tickets ordered by phone. E-ticketing, as it is now more often referred, has since become the norm, virtually supplanting paper tickets for all airline tickets purchased “online,” whether by phone or web.

Though embraced by the airline industry (and, more generally, the travel industries), e-ticketing has met somewhat tepid response in other markets. The entertainment and sports industries, for example, have been slow in their adoption.

This might be explained by the more impulsive nature of entertainment/sports event ticket purchases. Buying decisions are often not made until purchasers are queueing for admission, rendering the issuance of e-tickets unnecessary if not downright awkward.

For long-planned purchases, such as for seasons tickets for professional arts and sports events, the old-fashioned paper ticket is often preferred by buyers. Play- and opera-goers routinely give away tickets at the last minute to business and social acquaintances. Paper tickets, which transfer so readily from hand to hand and for which presentment is typically the only requirement of attendance, suit this well; not so, electronic tickets. While pop music concert goers and sports aficionados often give away tickets, their Machiavellian instincts sometimes lead to their asking a price, perhaps, even above face value. For these venues, too, paper tickets are a veritable necessity.

An object of the invention is to provide improved systems and methods of electronic ticketing.

A related object is to provide such systems and methods as are suitable for sports and entertainment events, alike, among others.

A further object is to provide such systems and methods as support electronic tickets that can be readily transferred form buyer to buyer.

Yet a still further object of the invention is to provide such systems and methods as afford those who put on the sports and entertainment events (among others) an opportunity to participate in downstream sales.

### SUMMARY OF INVENTION

The foregoing are among the objects attained by the invention which provides, in some aspects, a digital ticketing system, comprising first and second digital data devices (e.g., cell phones, PDAs, etc.) that are coupled, at least intermittently, with a server via a network. The server responds to a request, e.g., from the first digital data device, by electronically issuing to it a ticket for use by a holder thereof in gaining a seating (or other selected attendance) at an event. The server responds to a subsequent request, e.g., by the second digital data device, by (re)issuing the ticket to it for use by a holder of that second device in gaining the aforesaid seating (or other selected attendance) at the event in lieu of that by the holder of the first digital data device.

Related aspects of the invention provide systems, e.g., as described above, in which the server digital data processor issues the ticket substantially identically to the first and second digital data devices.

Still other related aspects of the invention provide systems, e.g., as described above, in which the server obtains and/or maintains authenticating data concerning the digital data devices and/or their respective holders. This can include, for example, an ID associated with those devices and/or people.

Yet still further aspects of the invention provide systems as described above in which the authenticating data includes any of a credit card number, a drivers license identification, a unique ID assigned by the server, and an image of a holder of a said digital data device.

Related aspects of the invention provide systems, e.g., as described above, that include a point-of-sale digital data device (“POS device”) that is at least intermittently coupled to the server via the network and that facilitates validation, vis-a-vis the authenticating data, of a ticket presented by the holder of the second (or first) digital data device in gaining (or attempting to gain) access to the ticketed “seat” at the event. The POS device, which can be disposed, e.g., at the event venue, performs the validation by comparing the authenticating data obtained and/or maintained by the server (and, for example, communicated to the POS device) against an identification presented by the holder of the second (or first) digital data device and/or against identifying information provided by the device itself.

Further aspects of the invention provide systems, e.g., as described above, wherein the server issues differing tickets to the first and second digital data devices vis-à-vis gaining the same aforesaid seating (or other selected attendance) at the event, and wherein those differences pertain to authenticating data issued with the respective tickets. In systems according to these aspects of the invention, a POS device, e.g., disposed at the event venue, can perform validation by comparing (i) authenticating data electronically, magnetically, or optically (collectively, “electronically”) read with a ticket from a digital data device presented by the holder thereof in gaining (or attempting to gain) access to the ticketed spot at the event against (ii) authenticating data obtained and/or maintained by the server (and, for example, communicated to the POS device).

Further aspects of the invention provide systems, e.g., as described above, wherein the server alters the ticket issued to the first digital data device in connection with issuing the ticket for the same aforesaid seating (or other selected attendance) to the second digital data device. Thus, for example, in related aspects of the invention, the server can invalidate the ticket that had been issued to the first digital data device in connection with reissuing that ticket to the second digital data device—or, more generally, in issuing a ticket to the second digital data device for the same aforesaid seating (or other selected attendance).

Further aspects of the invention provide a digital ticketing system, e.g., as described above, in which the server transfers the ticket from the first digital data device to the second digital data device in response to concurrent requests from the devices and particularly, for example, requests made by the holders of those devices.

Those requests may occur, e.g., in connection with an auction in which the would-be seller (e.g., the holder of first device) requests to auction his/her ticket and in which the would-be buyer (e.g., the holder of second device) and, possibly others, bid to purchase it. Alternatively, or in addition, the concurrent requests may specify prices or price ranges at which the seller is willing to sell and the buyer is willing to buy the ticket.

Related aspects of the invention provide systems, e.g., as described above, in which the holders of the first and second digital data devices are remotely disposed from one another at a time of the concurrent requests. For example, unlike “scalpers” outside a professional entertainment venue, the holders of the devices in a system according to aspects of the present invention need not be near or know one another. Further related aspects of the invention provide systems, e.g., as described above, in which one or both of the digital data devices include a display, e.g., on which the ticket can be shown, yet, include functionality for withholding display of a face value (if any) associated with the ticket.

Further aspects of the invention provide systems, e.g., as described above, in which the server effects a transfer of money or other thing of value to the holder of the first digital data device in connection with transfer of the ticket to the second digital data device. That money can be transferred from the holder of the second digital data device or, more typically, his/her bank or other party in privity with the holder of that device. Alternatively, or in addition, the transfer of money or other thing of value can be from a third party.

Related aspects of the invention provide systems, e.g., as described above, in which the server transfers to a third party an indication of a value of the money or other thing of value transferred to the holder of the first digital data device in connection with transfer of the ticket to the second digital data device. The third party can be, for example, an event organizer and/or owner or operator of the venue at which the event is held or some other part connected therewith.

Further aspects of the invention provide systems, e.g., as described above, in which the server transfers money or other thing of value to the third party, instead or in addition to the foregoing. The value of that transfer to the third party can be, for example, based on the value of the transfer to the first party. Thus, for example, the server can transfer to the third party an amount equal to, say, four percent of the price paid for the ticket by the holder of the second digital data device to the holder of the first digital data device.

In still other aspects, the invention provides systems, e.g., as described above, in which the server effects an exchange of tickets between digital data devices. Thus, for example, it can effect transfer to the second digital data device a ticket previously issued to the first digital data device, while effecting transfer to the first digital data device a ticket previously issued to the second digital data device. As above, this can be in connection with concurrent requests by holders of the respective digital data devices, e.g., as part of an auction and/or where those parties make requests (e.g., via the server) to exchange tickets with others. This can include, for example, a request by the holder of the first digital data device for acquisition of a ticket with privileges of a type associated with the ticket previously issued to the second digital data device, and vice versa.

Further aspects of the invention provide systems, e.g., as described above, in which tickets transferred to a digital data device can be used by the holder of that device on other devices held by him/her.

In other aspects, the invention provides systems, e.g., as described above, in which the server effects an exchange of a ticket on a device with a ticket on another device and/or with a ticket held (for example, at the behest of an event operator), e.g., on the server itself.

Still further aspects of the invention provides systems, e.g., as described above, in which the server issues to a first digital data device an option to obtain a ticket good for attendance at an event. This can be, for example, in response to a request issued from that device by the holder thereof, e.g., via a webpage or otherwise. Issuance of the option to the device can be in exchange for money (which can, for example, be transferred from a bank account of the device holder or otherwise, as described above). The server responds to a subsequent request by converting the option to a ticket for use in gaining a selected attendance to the event.

In lieu of issuance of a ticket to the first digital data device, in related aspects, the server of a system, e.g., as described above, responds to a subsequent request by transferring the option from the first digital data device to a second digital data device, e.g., in the manner of a digital ticket, as described above. As above, this can be, for example, in response, e.g., to a request issued from a webpage or otherwise, and it can be in exchange for money or other thing of value. In related aspects of the invention, the server converts the option that was transferred to the second device to a ticket for use by the holder of that device in gaining selected attendance at the event.

Related aspects of the invention provide systems, e.g., as described above, in which the server and the digital data devices cooperate in the issuance, re-issuance and/or exchange of options in a manner paralleling that for digital tickets described above. Thus, for example, the server can issue (and reissue) an option substantially identically to the first and second digital data devices; the server can obtain and/or maintain authenticating data concerning the digital data devices and/or their respective holders in connection with the issuance and/or reinsurance of options; the server can issue differing options to the first and second digital data devices vis-à-vis gaining the same aforesaid seating (or other selected attendance) at an event; the server can alter the option issued to the first digital data device in connection with issuing the option for the same aforesaid seating (or other selected attendance) to the second digital data device; the server can transfer the option from the first digital data device to the second digital data device in response to concurrent requests from the devices and particularly, for example, requests made by the holders of those devices; the server can effect a transfer of money or other thing of value to the holder of the first digital data device in connection with transfer of the option to the second digital data device; and so forth, all by way of example and all paralleling similar actions vis-a-vis tickets, as described above.

Related aspects of the invention provide systems, e.g., as described above, in which the server effects an exchange of money or other thing of value between the holders of the digital data devices and/or third parties in connection with an exchange of tickets as described above.

Still further aspects of the invention provides systems, e.g., as described above, in which the server uses selective optimization to transfer tickets between (or among) multiple digital data devices. In related aspects, the server mediates an exchange of tickets by solution of a weighted matching problem, optimizing desires of holders of the respective multiple devices.

Other aspects of the invention provide systems, e.g., as described above, that provide for notification of holders of tickets (or options) of sale and/or exchange transactions in which they can participate, which notifications can be disabled by a server, e.g., to avoid confusion among multiple recipients.

Yet still further aspects of the invention provide systems, e.g., as described above that employ mobile smart-phones, mobile PDAs, etc. as the digital data devices. Still other related aspects provide such systems as utilize desktop computers, laptop computers or other “stationary” digital data processors as the digital data devices.

Still yet further aspects of the invention provide systems, e.g., as described above, in which a ticket (or option) transferred from a first digital data device to a second digital data device can, further, be transferred to a third such device, and so forth.

Further aspects of the invention provide methods of digital ticketing paralleling the operations described above.

### BRIEF DESCRIPTION OF THE DRAWINGS

A further appreciation of the invention may be attained by reference to the drawings, in which

FIG. 1 depicts a system according to the invention and an environment in which it operates;

FIG. 2 depicts a system and method according to the invention for issuance and transfer of digital tickets, e.g., for money;

FIG. 3 depicts a system and method according to the invention for the exchange of previously issued digital tickets;

FIGS. 4 and 5 depict a system and method according to the invention for validation of digital tickets; and

FIG. 6 depicts a system and method according to the invention for conversion of an option to a digital ticket.

### DETAILED DESCRIPTION OF THE ILLUSTRATED EMBODIMENT

Architecture

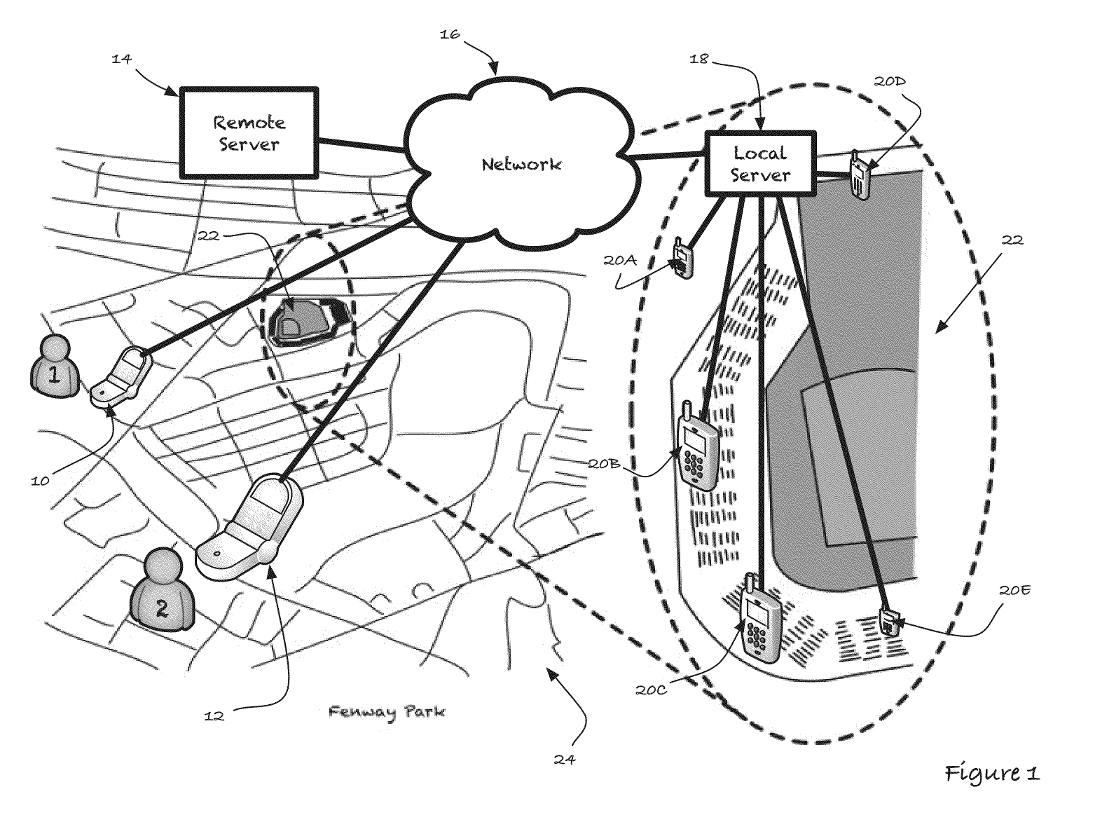

FIG. 1 depicts a system for digital ticketing according to one practice of the invention. The illustrated system includes digital data devices, 10, 12 that are coupled to server 14 via network 16. Also coupled to network 16 are a local server and point of sale (POS) devices 20A-20E. The illustrated system is depicted here and described below in an application that includes issuing and reissuing tickets for an event held at a venue, here, a baseball park 20 (for example, Fenway Park) in a region 24 of a city (for example, Boston), although it will be appreciated that the system (and methods of operation thereof) have application to ticketing in a wide variety of events regardless of venue. It will also be appreciated that other embodiments may employ architectures other than that shown by way of example here.

Digital data devices, 10, 12 of the illustrated embodiment are conventional computing devices of the type commercially available in the marketplace for use in mobile computing, e.g., smart phones, personal digital assistants (PDAs), and so forth, as adapted in accord with the teachings hereof. In other embodiments, the digital data devices can be other portable, semi-portable or fixed computing devices, such as laptop computers, desktop computers, workstations, and so forth, of the type commercially available in the marketplace, again, as adapted in accord with the teachings hereof. As well, they can include embedded computing devices as adapted in accord with the teachings hereof. The digital data devices can transmit and/or receive information via cell phone “radio,” WiFi, infrared, Bluetooth, near field communication, and/or otherwise, all in the conventional manner known in the art as adapted in accord with the teachings hereof.

For simplicity without loss of generality, the digital data devices, 10, 12 are sometimes referred to herein as “cell phones,” “mobile phones,” and so forth.

Illustrated devices, 10, 12 each include central processing unit (CPU), memory (RAM), and input/output (I/O) subsections of the type commonly incorporated in respective devices of the type discussed above. Those subsections may include and execute (particularly, for example, in the case of the CPU) and operating system and a web browser (or other application or app) of the type commonly provided and configured for execution on such devices—again, as adapted in accord with the teachings hereof. The digital data devices, 10, 12 also include displays (not shown) of the type commonly in respective devices of the type discussed above, e.g., for the display of information in web browsers, applications, apps or otherwise. And, those devices, 10, 12 can include keyboards (virtual, physical or otherwise) of the type commonly employed on such devices, e.g., for the input of information into web browsers, applications, apps or otherwise.

Server digital data processors 14, 18 comprise conventional digital data processors of the type commercially available in the marketplace for use as web, commerce or other servers, such as, personal computers, workstations, mini computers, mainframes, and so forth—all as adapted in accord with the teachings hereof.

Server digital data processors 14, 18, too, may include central processing unit (CPU), memory (RAM), and input/output (I/O) subsections of the type commonly incorporated in respective devices of the type described above. Those subsections may include and execute (particularly, for example, in the case of the CPU) an operating system and a web server (or other application or app) of the type commonly provided and configured for execution on such device—again, as adapted in accord with the teachings hereof.

Together, servers 14, 18 oversee digital ticketing, ticket transfers, and ticket validation in accord with the teachings hereof. Although their operations may be combined, e.g., in one device, here, server 14 oversees ticket issuance and ticket transfers to and among the digital data devices, 10, 12, while server 18 oversees validation of those tickets when presented by the holders of devices 10, 12 at the venue 22 for admission to and seating at the ticketed event.

Network 16 comprises a combination of one or more wireless, wired for other networks of the type commercially available in the marketplace for supporting at least intermittent communications between the illustrated devices (e.g., digital data devices, 10, 12 and server 14, 18), including, for example, cellular, Wi-Fi, local area, satellite, and/or other networks—again, all as adapted in accord with the teachings herein. Although only a single network 16 is shown in the drawing, it will be appreciated that in other embodiments multiple networks may be employed, e.g., an Internet and mobile network for communications between devices, 10, 12 and server 14, and a separate local area network for communications between local server 18 and POS devices 20A-20E.

Point of sale (POS) devices 20A-20E comprise barcode scanners, magnetic strip scanners, and the like, of the type commercially available in the marketplace and suitable for magnetically, electromagnetically, electromechanically, optically or otherwise sensing data presented by and/or contained in a device, such as, digital data devices, 10, 12. The devices 20A-20E can transmit and/or receive information via cell phone “radio,” WiFi, infrared, Bluetooth, near field communication, and/or otherwise, all in the conventional manner known in the art as adapted in accord with the teachings hereof. The data may be a code reflecting a digital ticket issued (and/or transferred) to the device, an identification of the device, an identification of its holder (e.g., a drivers license ID, a credit card number, and so forth), authentication data issued by the server 14 in connection or otherwise associated with any of the foregoing, and so forth.

Issuance and Re-Issuance of Digital Tickets, e.g., for Money

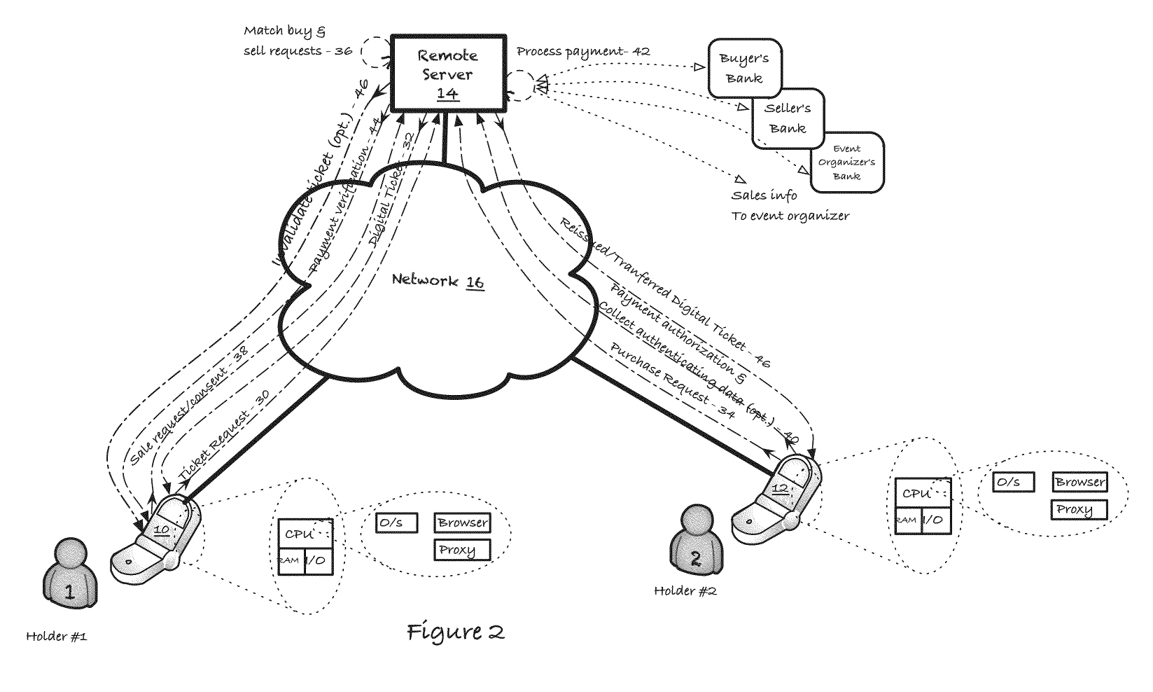

FIG. 2 illustrates a mechanism for issuing and reissuing (i.e., transferring) digital tickets in a system according to the invention—and, typically, communications between digital data devices, 10, 12 and server 14 in support thereof.

Initial Ticket Purchase and Issuance

In step 30, digital data device 10 issues to server 14 a request for a ticket to an event, for example, a baseball game. Depending upon the type of event, the request may be for general admission or, more typically, for a type or class of admission, such as seating in a specified level, region or type of seating—or for seating in a specific seat. In the discussion that follows, for sake of simplicity and without loss of generality, the request is assumed to be for seating. The request may be communicated by a web page form(s) (e.g., via HTTP or otherwise), by special-purpose application or app, by e-mail or otherwise.

In step 32, the server 14 transmits a ticket for the requested seating to digital data device 10. The ticket may be in any suitable digital form, e.g., a text file, a PDF file, and so forth. Preferably, however, the digital ticket is in a format, such as, PDF, that is suitable for digital signing or certification, e.g., in a manner conventional in the art as adapted in accord with the teachings hereof. Transmission of the ticket may be via webpage, special-purpose application or app, e-mail or other format suitable for such transmission.

Although not shown in the drawing or discussed otherwise here, step 32 also includes payment authorization of the type conventional in the marketplace for online ticket purchases i.e., authorization by the holder (e.g., owner) of device 10 for the purchased ticket and corresponding transfers of payment by server 14, easy, as between that holders bank, the event organizer (or other third party), or otherwise.

Re-Issuance of Ticket to Another Client Device

In step 34, digital data device 12 issues to server 14 a request for the ticket already issued to the holder of digital data device 10. This may be a targeted request for that specific ticket or, more commonly, a request for similar or identical seating as that covered by that ticket. The request, which may be communicated a web page form(s) (e.g., via HTTP or otherwise), by special-purpose application or app, by e-mail or otherwise, may be made ad hoc, in connection with an auction (e.g., in concert with holders of other digital data devices who are also interested in such seating) or otherwise, and it may specify a price or price range which the holder of device 12 is willing to pay for the ticket.

In step 36, the server 14 seeks to match the “buy” request for the ticket from device 12 with a concurrent “sell” request for the ticket from device 10. This can include, for example, searching a queue of “sell” requests maintained by server 14 (from current ticket holders, e.g., the holder of device 10) for a ticket matching the seating and pricing conditions specified in the request from device 12. Alternatively or in addition, this can include checking for active auctions (e.g., executed from server 14 or otherwise) for such matching seating.

Where no such pre-existing matching “sell” request exists, it can also include querying the holder of device 10, from server 14 or otherwise, to discern whether he/she indeed wishes to sell his/her ticket. See step 38. This can be accomplished by webpage, special-purpose application, e-mail or otherwise.

Multiple Simultaneous Requests

In instances where the holders of three or more devices utilize the illustrated system to buy and/or sell tickets, the server 14 (and/or server 18) can use selective optimization in order to best allocate/match requests among the holders. That optimization can be based on price, desirability of seating, loyalty of potential buyers/sellers, and so forth, and it can be based on solution of a weighted matching problem or other suitable optimization technique known in the art or otherwise.

Holders of the digital data devices can utilize this feature, for example, to exchange (tickets for) seats in small or large groups for a given event or events, e.g., allowing friends or colleagues to sit and/or otherwise attend the event together. Such groups actions can be taken into account during optimization and/or otherwise.

Payment by Holder of Acquiring Device and/or Third Party

Upon matching “buy” and “sell” requests, the server 14 queries device 12 for payment authorization. See step that 40. This can be accomplished in the conventional manner known in the art for authorizing payments, e.g., by webpage, special-purpose application, e-mail or otherwise. Data collected during this step, e.g., account names, etc., can be retained by the server 14 for subsequent use in completing transactions for device 12 and/or the holder thereof (e.g., for the same or different events).

Upon receiving the requisite authorization, the server 14 transfers funds between a bank account associated with the holder of device 12 and a bank associated with the holder of device 10, or otherwise. See step 42.

In connection therewith, in some embodiments of the server also transfers funds to a bank account associated with the event organizer or other third party. That transfer can be based, for example, on an amount paid for the ticket by the holder of device 12 and can be, for example, a fraction (such as, by way of non-limiting example, four percent) thereof. The server 14 can, instead or in addition, transmit a message to the event organizer (or other third party) indicating an amount paid by the holder device 12 for the ticket.

In some embodiments, the server 14 obtains payment from a party other than the holder of device 12. That third-party may be a contest organizer or otherwise. In such instances, the funds transfers of step 42 are exercised with respect to the bank of that third-party (not the bank of the holder of device 12). In step 44, the server 14 transmits a payment authentication to device 10 for the benefit of the holder thereof, and, in step 46, transmits the ticket—effectively, reissuing it—to device 12 for the benefit of the holder thereof (i.e., so he/she can attend the event in lieu of the holder of device 10).

Preventing Misuse of Ticket: Validating Ticket and/or Holder

Having reissued to device 12 the ticket previously issued to device 10, the illustrated system uses any of several strategies to prevent the current and prior holders of the ticket from both gaining admission to the event and/or taking the ticketed seat. These vary, for example, depending on whether a particular embodiment utilizes “static” digital tickets (e.g., in which the originally issued ticket is not changed on the device 10, even though reissued to the other device 12) or “dynamic” digital tickets (e.g., in which the originally issued ticket is changed on the device 10, e.g., in connection with being reissued to the other device 12).

For example, in some embodiments that utilize dynamics tickets, the server 14 issues and reissues a given ticket identically to devices 10 and 12, respectively, but electronically removes or voids the ticket previously issued to device 10 once that ticket has been reissued to device 12—thereby, preventing the prior holder (i.e. the holder of device 10) from presenting the ticket to gain admission to the event and/or to take the ticketed seating. Such invalidation can be effected, for example, by communication between the server 14 and a proxy (e.g., of the type shown in the drawing) that executes on the digital data devices, 10, 12—and, particularly, at least, for example, on the device (in this case, device 10) for which the ticket is to be invalidated. In such embodiments, having once reissued the ticket to device 12 (which, itself, can be confirmed through the proxy executing on that device), the server 14 can instruct the proxy executing on device 10 to remove all traces of the ticket therefrom or, alternatively, to electronically mark the ticket as invalid—so, for example, that the holder of device 10 and, for example, any ticketing agents at the event (as well as others) can see that the ticket is no longer valid and so that POS devices 20A-20E can detect that also.

Other embodiments rely on alternate strategies, instead or in addition. For example, the server 14 can issue different forms (or instantiations) of the ticket to each of the devices 10, 12. That is, it can issue a first instantiation of the ticket to device 10 in step 32, and a second instantiation of that same ticket in step 46. While this strategy can be used for embodiments employing dynamic tickets, it can be particularly useful in those utilizing static tickets.

Thus, for example, each instantiation of a given ticket and, particularly, that instantiation issued to the second device (i.e., device 12) can include (or otherwise be transmitted by the server 14 to device 12 and stored thereto in association with the ticket) a unique ID, an encrypted code, a hidden code, and/or other authenticating data generated by server 14 (or otherwise). The server 14 can also separately retain and/or provide that data to POS devices 20A-20E (eg, via server 18) for use in validating the ticket upon presentiment by the holder thereof.

Conversely, or in addition, whether utilizing dynamic or static tickets, the server 14 can collect, as authenticating data, information from the device to which the ticket is transmitted and/or from the holder thereof (as well, potentially, from other sources) in connection with ticket issuance (e.g., in step 32) or re-issuance (e.g., in step 46). For example, the server 14 can collect from device 12 and/or the holder thereof, in step 40 (or otherwise) a drivers license number, a credit card number, a phone number (e.g., the phone number assigned to device 12), a device ID, or otherwise. As above, the server can separately retain and/or provide that information to POS devices 20A-20E for use in validating the ticket upon presentiment by the holder thereof. Data collected during this step, e.g., driver license number, etc., can be retained by the server 14 for subsequent use in authenticating other transactions for device 12 and/or the holder thereof.

Preventing Price Collusion

It has been said that ticket scalping is illegal because it does not afford event organizers a “piece of the action”—or, put another way, it does not allow event organizers to economically benefit from higher pricing of tickets sold to downstream purchasers (and, conversely shields them from the risks associates with lower such pricing).

Regardless, in some embodiments, server 14 prevents the transfer of tickets between digital data devices (and, likewise, holders thereof) that are situated near one another—and, thus, prevents possible collusion by the holders of those devices in setting prices for the exchanged ticket. The server 14 can determine proximity, for example, from GPS data supplied to it by the respective devices 10, 12, and/or utilizing cell phone tower (or Wi-Fi) location-determination techniques of the type known in the art, as adapted in accord with the teachings herein. Likewise, in some embodiments, server 14 or proxies executing on the digital data devices 10, 12 prevent the display of “face value” or other pricing information on digital tickets issued to the devices 10, 12.

In these and/or other embodiments, the server 14 can, as noted above, cut the event organizer (or other third-party) in on the (economic) action, e.g., by transferring funds to its bank account based, for example, on an amount paid for the ticket by the holder of device 12 and/or can notify that organizer (or third party) of that amount.

Exchanging Digital Tickets for Other Digital Tickets or Things of Value

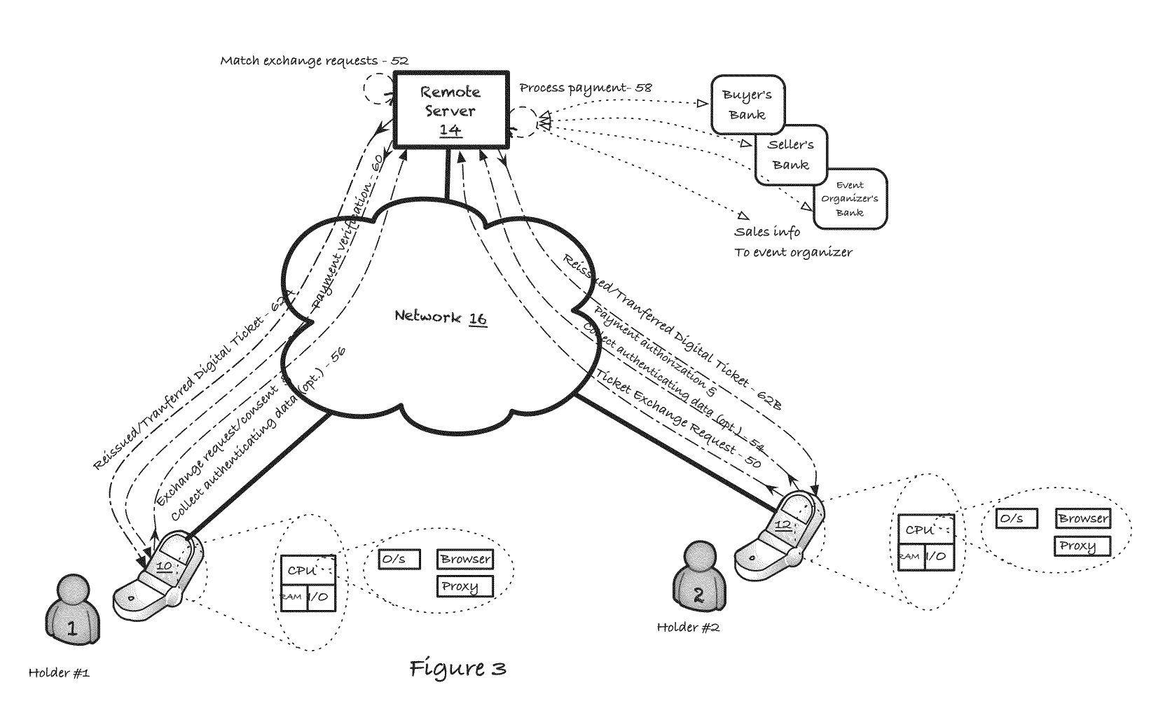

Referring to FIG. 3, the server 14 can effect exchanges of digital tickets on one device with digital tickets or other things of value (e.g., credits, barter, etc.).

Exchanges Between Devices

For example, such exchanges can be effected between the devices 10, 12 in lieu of, or in addition to, an exchange of money. Holders of the digital data devices 10, 12 can utilize this feature, for example, to exchange seats in a given event that is upcoming or ongoing (e.g., allowing a ticket holder or group of holders to improve or otherwise change their seating in exchange with another holder or holders), as well as to exchange tickets for different events.

Embodiments permitting this generally operate in the manner of FIG. 2, with differences as discussed below. In the discussion that follows, it is assumed that the server 14 had previously issued digital tickets to each of devices 10, 12 (e.g., in the first instance utilizing a mechanism of the type discussed above in connection with steps 30, 32 or otherwise).

Requests

In step 50, digital data device 12 issues to server 14 a request to exchange tickets with another who holds a ticket with specified privileges, e.g., for attendance on a specific date or date range, for seating in a specified section of the event forum, and so forth. This may be a targeted request to make an exchange for a specific ticket or, more commonly, a request for any ticket with the specified privileges.

The request, which may be communicated a web page form(s) (e.g., via HTTP or otherwise), by special-purpose application or app, by e-mail or otherwise, may be made ad hoc, in connection with an auction (e.g., in concert with holders of other digital data devices who are also interested in such seating) or otherwise, and it may, optionally, specify a price or price range which the holder of device 12 is willing to pay for the ticket—in addition to exchange of a ticket currently had by the holder of device 12.

Matching Requests

In step 52, the server 14 seeks to match the exchange request for the ticket from device 12 with a concurrent exchange request from another device, specifically, for a ticket with privileges of the type associated with the ticket previously issued to the holder of device 12. This can include, for example, searching a queue of exchange requests maintained by server 14, checking for active auctions, and so forth, as discussed above in connection with FIG. 2. Where no such pre-existing matching exchange request exists, it can also include querying the holder of other devices, e.g., device 10, to discern whether he/she/they indeed wishes to exchange his/her ticket. See step 54. This can be accomplished by webpage, special-purpose application, e-mail or otherwise.

Exchange of Tickets and Money or Other Things of Value

If the holder of device 12 had agreed to pay a price for the exchange (and/or vice versa), upon matching exchange requests, the server 14 queries device 12 (and/or device 10, if the holder of it had agreed to make payment for the exchange) for payment authorization and transfers funds between bank accounts of the device holders, the event organizer and/or third parties, as above. See steps 56, 58. As above, the forgoing include instances where a third-party agreed to pay for or subsidize partial costs of the exchange.

In step 60, the server 14 transmits a payment authentication to device 10 for the benefit of the holder thereof, and, in steps 62A, 62B transmits the tickets previously issued to each of the devices 10, 12 to the other device 12, 10—effectively, exchanging them.

Conversely, or in addition, if the holder of device 12 had agreed to exchange other things of value (in addition to tickets), the server in steps 56-60 mediates and confirms that exchange as appropriate for the type of item exchanged.

MultiWay Ticket Exchanges

As above, in instances where the holders of three or more devices utilize the illustrated system to exchange tickets with one another, the server 14 (and/or server 18) can use selective optimization in order to best allocate/match requests among those parties. That optimization can be based on price, desirability of seating, loyalty of potential buyers/sellers, and so forth, and it can be based on solution of a weighted matching problem or other suitable optimization calculation known in the art or otherwise.

Holders of the digital data devices can utilize this feature, for example, to exchange seats tickets in small or large groups for a given event or events, e.g., allowing friends or colleagues to sit and/or otherwise attend the event together. Such groups actions can be taken into account during optimization and/or otherwise.

Upon matching exchange requests, the server 14 queries the device or devices 10, 12 for payment authorization, transfers funds and confirms same. See steps 56-60.

Preventing Misuse of Exchanged Tickets

Having exchanged the tickets, the illustrated system uses any of several strategies, e.g., as discussed above in connection with FIG. 2 in order to prevent the current and prior holders of the ticket from both gaining admission to the same ticketed seat. This can include, for example, electronically voiding the ticket previously issued to each respective device 10, 12, e.g., as discussed above in connection with step 46. This can also include, for example, generating, obtaining, and/or collecting authenticating data, e.g., as discussed above in connection with step 40, for use by the POS devices 20A-20E. As above, data collected during this step can be retained by the server 14 for subsequent use in authenticating other transactions for the devices and/or the holders thereof.

Other Exchanges

In addition to exchanges between devices, servers 14, 18 can effect exchanges of digital tickets on one device with digital tickets or other things of value (e.g., credits, etc.) from event organizers (and/or others). Organizers can use this feature, for example, to encourage holders of the digital data devices 10, 12 to shift their seating, e.g., so as to make the event forum or portions thereof appear better occupied (e.g., to a television audience), to better separate groups of fans, and so forth. Organizers can, instead or in addition, use the feature to reissue tickets, e.g., for cancelled or rescheduled concerts; to distribute, consolidate or otherwise alter numbers and/or demographics of attendance at events; and so forth, all by way of example.

Embodiments permitting this operate as discussed in the sections immediately above vis-a-vis exchanges of tickets (and/or other things of value) between digital data devices. Differences in embodiments permitting exchanges with event organizers (and/or others) include, for example, the following:
vis-a-vis step 50, either the server 14 or a digital data device 12 to which a ticket has already been transferred, might initiate a request to exchange tickets. Server-initiated requests may be issued to the device 12, for example, at the behest of an event organizers, e.g., for reasons of the type discussed above. The server 14, 18 can notify the device or its holder, e.g., via e-mail, text messaging, an in-app messaging or otherwise. Regardless, such messaging can specify details of an exchange (e.g., a ticket for an event on a date certain in exchange for an already issued ticket for a like event on another date), including a fee or credit for the exchange.
vis-a-vis step 52, the server 14, 18 matches any a request or acknowledgement from the device 12 with an exchange queued up in the server, e.g., at the behest of the event organizer.
vis-a-vis steps 56, 58, the server 14, 18 oversees any transfer of funds as between accounts associated with the holder of device 12, the event organizer and/or a third-party.
vis-a-vis step 60, the server 14, 18 transmits an authentication to the event organizer, as necessary.
vis-a-vis steps 62, the server 14, 18 transmits a new ticket to device 12, while invalidating or voiding a ticket previously issued. As discussed elsewhere herein, such invalidation/voiding is not necessary in all embodiments.

Validation of Digital Tickets at the Venue

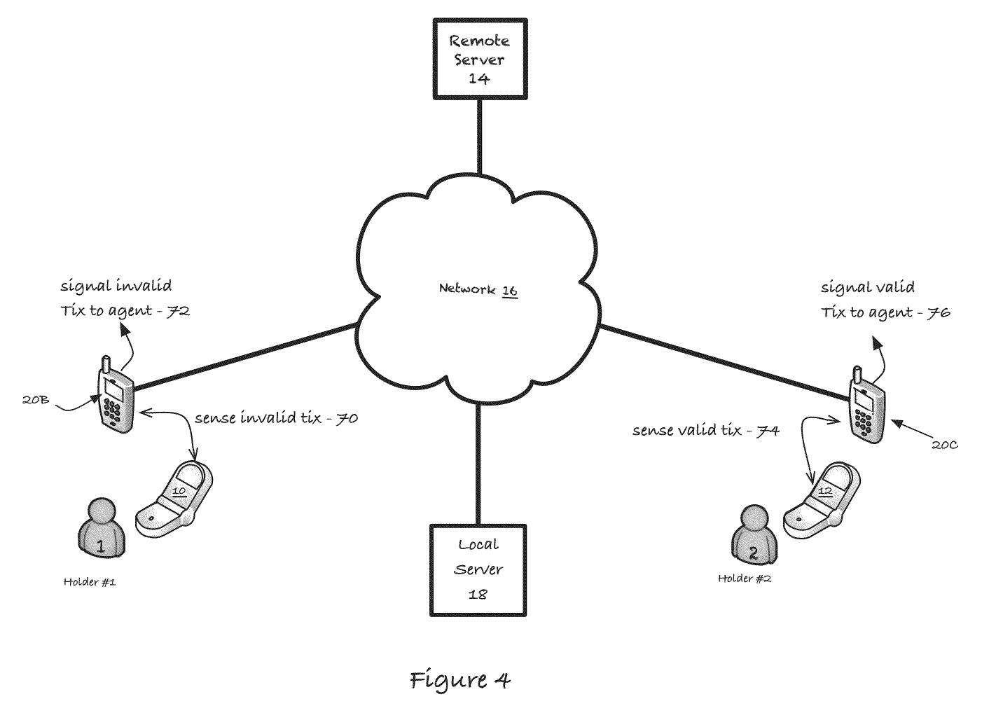

FIG. 4 illustrates a mechanism for validating digital tickets upon presentation by the holders of devices 10, 12 at the venue 22 for admission to and seating at the ticketed event in a system according to the invention—and, particularly, for example, communications between the digital data devices 10, 12 and servers 14, 18 for such validation.

Discussion of such validation is had, by way of non-limiting example, with respect to an exemplary instance of the type described above in connection with steps 44, 46 in which, following transmittal of payment, the server 14 has transmitted (and, effectively, reissued) to device 12 for the benefit of the holder thereof a ticket previously issued to device 10. It will be readily appreciated, in view of this discussion, how such validation is effected by the illustrated system in other instances following issuance and/or exchange of digital tickets in accord with the teachings herein.

In the illustrated instance of FIG. 4, it is assumed that the holders of both devices 10, 12 present themselves at the venue 22 for admission and seating following the aforementioned digital ticket transfer. Thus, for example, the holders of devices 10, 12 present at admission gates of the venue 22, where POS 20B and 20C are employed by a ticket-collecting agents to validate admission and seating.

To ensure that only the holder of device 12 is granted admission for use of the ticketed seat (in the instance of this particular example), the POS devices 20B and 20C (e.g., working in conjunction with local server 18) facilitate comparing authentication data provided by the server 14 as collected in connection with ticket issuance and/or re-issuance with information presented by the devices 10, 12, and/or the holders thereof at the time of presentment.

Depending on the particulars of the embodiment, the POS devices may perform such comparison and validation of their own, e.g., utilizing software executing on embedded processors contained within those devices (in the conventional manner known in the art, as adapted in accord with the teachings herein). Alternatively, or in addition, the POS devices may facilitate such comparison and validation by sensing and/or otherwise collecting the relevant information for presentation and decision-making by the ticket-collecting agents.

Validation of Tickets in Instances where Re-Issuance Includes Voiding Prior Ticket

In embodiments, e.g., of the type described in connection with optional step 46, wherein the server 14 electronically removed or voided the ticket previously issued to device 10 (in this example), the POS device 20B signals the ticket-collecting agent that the holder of device 10 is to be refused admission upon sensing, magnetically, electromagnetically, electromechanically, optically or otherwise, that any remnant of the ticket previously issued to device 10 has been so voided. See steps 70, 72. Conversely, the POS device 20C signals the ticket collecting agent that the holder of device 12 is to be granted admission upon sensing that a valid ticket has been issued to that device (and not, itself, removed or voided). See steps 74, 76.

Validation of Tickets in Instances where Issued and Reissued Tickets Differ

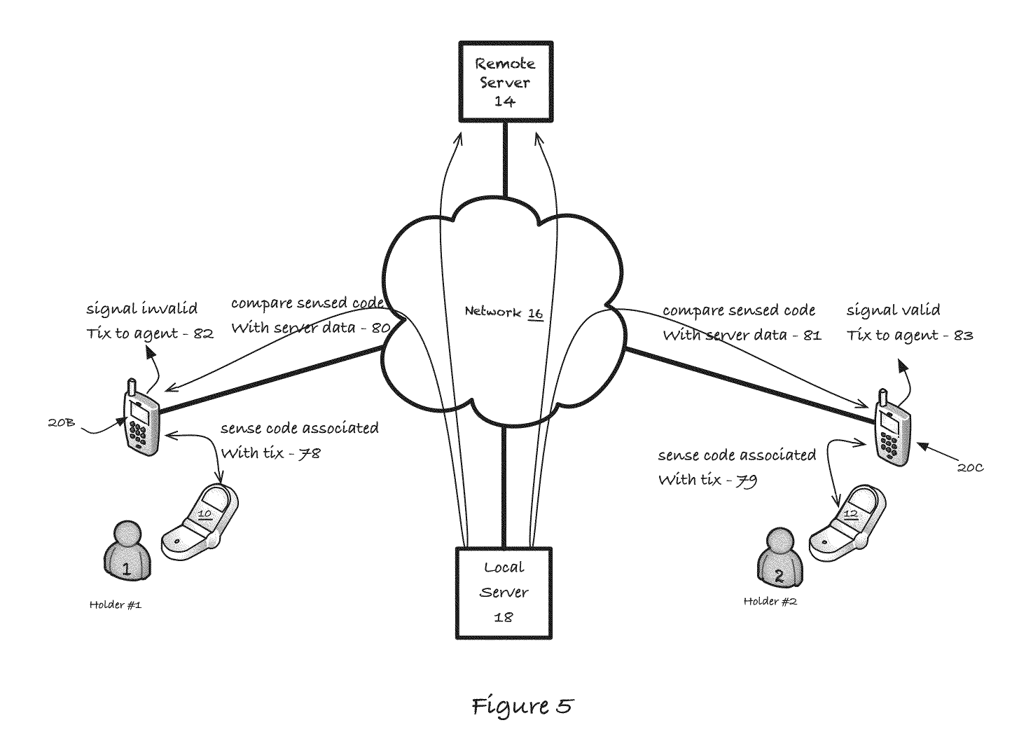

Referring to FIG. 5, in embodiments in which the server 14 issues different forms (or instantiations) of the ticket to each of the devices 10, 12, e.g., in connection with steps 32, 46, the POS device 20B senses the ID, encrypted code, hidden code, and/or other authenticating data stored to device 10 in association with the tickets that had been issued to it; see step 78. The POS device 20C likewise senses the ID, encrypted code, hidden code, and/or other authenticating data stored to device 12 in association with the tickets that had been issued to it; see step 79.

Working in conjunction with local server 18, the POS device 20B, 20C can compare that sensed data with the authenticating data retained separately by it for use in validation. See steps 80, 81. That separately retained data can be retrieved by the POS devices at the time of presentment by the holders of devices 10, 12 or it can have been previously “pushed” by the remote server 14 to the local server 18, e.g., prior to the event (e.g., 30 minutes before the event).

In the exemplary instance discussed here, that comparison should reveal that the code associated with the digital ticket issued to device 10 is not, while the code associated with the digital ticket issued to device 12 is, the code of the most recently issued (or, more precisely, the recently re-issued) ticket. Accordingly, in steps 82, 83, the POS devices 20B, 20C signal the agents as to the validity of the respective tickets.

Using Device/Holder Data for Validation

In embodiments in which the server (additionally) collects, as authenticating data, information from the device to which the ticket is transmitted and/or from the holder thereof in connection with ticket issuance (e.g., in step 32) or re-issuance (e.g., in step 46), the POS devices 20B, 20C can obtain that (additional) authenticating data from the respective devices 10, 12, respectively, and/or the holders thereof (or can signal the ticket-collecting agents to obtain such information). As above, working in conjunction with the local server 18, the POS devices can compare that (additional) data with authenticating data separately retained by the server and retrieved by the POS devices at the time of presentment (or previously pushed thereto). In the exemplary instance discussed here, that comparison should reveal (in such instances) that the additional authenticating data associated with the digital ticket issued to device 10 is not, while the code associated with digital to device 12 is, the authenticating data of the most recently issued (or, more precisely, the recently reissued) ticket. The POS devices can signal the ticket-collecting agents accordingly in steps 82, 83.

Multiple Associated Devices

Although in the embodiments shown in the drawings and discussed above, a single device (e.g., cell phone) is associated with each “device holder” (e.g., each digital data device owner who is an actual or potential buyer or seller of digital tickets or options), it will be appreciated that systems and methods according to the application can be used with multiple associated digital data devices owned or used by any such person. More specifically, in some embodiments, a ticket transferred to any digital data device held by such person is available to that person on any of his or her other digital data devices. This is beneficial, for example, in allowing a device holder to buy a ticket using one associated device and to use another of his/her associated devices to (i) for display (or other use) of that ticket to gain admission/seating at the ticketed event, (ii) initiate and authorize sale of that ticket to another user, (iii) otherwise use the ticket as if he/she had purchased it on that other associated device in the first instance.

In some embodiments with this “single holder/multiple device” functionality, such functionality is supported via tables, databases, lists, or the like, that are maintained by the servers 14 and/or 18 that identify associated digital data devices, i.e., the digital data devices owned by each “holder.” Those tables, databases, etc. can be populated by the servers 14 and/or 18 using information provided by each holder, e.g., during account setup and/or during other interactions (e.g., via a web site, special purpose app, or otherwise) between the holder and the server(s)—specifically, information from the holder identifying the associated devices he/she expects to use with systems according to the invention. Such information can, instead or in addition, be attained by proxies or other software running on those devices at the behest of the server(s) 14, 18.

The server 14 can use those tables, databases, etc., for example, to discern which devices tickets or options should be transferred to, e.g., in steps 32, 46, 62A, 62B; in connection with collection of authentication data for the devices, e.g., in steps 40, 54, and 56; in connection with authentication of tickets presented via the devices for admission seating, e.g., in steps 70-76; in connection with invalidation or voiding of previously issued tickets, e.g., in step 46; all by way of example.

Facilitating Purchase or Exchange of Multiple Tickets

As noted elsewhere herein, requests to purchase or exchange tickets can be for general admission or for more specific types or classes of admission (e.g., seating in a specified level, region, or for seating in a specific seat). If the requests are for tickets that have not already been sold, the server can 14 can effect a transaction of the sort discussed in connection with steps 30-32.

In regard to requests for individual seats, particularly, in instances where tickets for those seats have already been sold, the server 14 can facilitate response the requests by querying (e.g., via email or text messaging) the respective ticket holders to ascertain their interest in selling to or swapping with the requester. If so, the server can effect the transactions, e.g., as discussed above in connection with FIGS. 2 and 3.

More complicated are instances where requests for seats that have already been sold are of a more general in nature and/or where facilitating response to those requests would require messaging a large number of ticket holders—each of whom may be potentially slow in responding to indicate potential interest and/or, ultimately, to agree to or reject the requested purchase or exchange. While the server can message those ticket holders as above, that is likely to lead to annoyance, confusion, etc. Preferably, the server 14 utilizes a signaling mechanism for at least some of those ticket holders in such instances, e.g., a mechanism that serves to alert the holders when there is a potential interest in their respective tickets, yet, that can be readily disabled (e.g., by the server) if that request is met by another holder (hence, minimizing annoyance and/or confusion).

One such mechanism is a badge, beacon, popup or other indicator (visual, audio, tactile, vibratory or otherwise) that the server 14 activates on each such ticket holder's associated mobile devices—e.g., via an app, application or proxy executing on those devices—when there is pending a request implicating the ticket held by the holder of that device (and particularly, for example, a pending request that could lead to the sale or exchange of such an implicated ticket), and that the server deactivates when that request is satisfied (e.g., by any of the implicated ticket holders or otherwise) or is otherwise no longer pending (e.g., because it is withdrawn by the original requester or otherwise). Preferably, the indicator can also be deactivated (if not merely ignored) by the holder of the device as he/she sees fit. Instead of, or in addition to, an indicator on the devices, the server 14 can drive the indicator to and control its status on a web page or other site accessible via the devices and/or their holders.

In some embodiments, the indicator may have two states: active and inactive. In other embodiments, it may have an additional state, e.g., indicating that there is a request outstanding for the ticket held by the device owner, which request is in the process of being satisfied by another device holder (or being satisfied otherwise). The server 14 of still other embodiments may drive the indicator in these and/or still other states.

In addition to altering the statue of the indicator on a device-resident app, application or proxy and/or on a web or other site, the server 14 can interact with that app, application, proxy, site, etc. to permit the holder of a device to (1) respond, e.g., affirmatively or negatively, to the request that resulted in activation of the indicator, (2) reset the indicator, (3) obtain further information regarding monetary and/or other terms of the purchase and/or exchange underlying the request, and/or (4) to make a supplemental request, e.g., indicating that the holder would be willing to sell his/her ticket to the requester in exchange for a ticket elsewhere in the venue, a ticket for another event, and so forth.

The server 14 can utilize logic similar to that used to solve the so-called “bin packing problem” (and its variants) to solve the more complicated situation alluded to above. This can include “on-line” logic providing a solution when requests arrive one at a time and must be immediately satisfied, and/or “off-line” logic providing a solution where all requests are given before any allocation happens.
Approach 1: Seats are allocated and each new request results in a plan of seat swaps.
Approach 2: Seats are allocated but seat swaps are queued until there are a sufficient number of them and the algorithm attempts to satisfy them all
Approach 3: Seats are not specifically allocated, however, they are assigned to meet the constraints in a way to ensure that everyone's requests are satisfied. This is the off-line version.

Note that case 3 can be satisfied by temporarily allocating seats but not informing their owners until the last moment, thereby making seat swapping an internal operation. Moving temporarily allocated seats in a way that violates the request specifics, would still require the explicit agreement by the purchaser.

Finding the sets of seats to be reassigned in order to accommodate adjacent seating of late purchases involves searching and iterating over a potentially large number of possibilities. It is assumed, that the database contains previously allocated seats, their owners, and associated constraints, such as the size of the party. When purchasing N seats it is assumed that these seats are all to be adjacent. A user interface may also allow the buyer to specify adjacency to another buyer.

Given a request for A adjacent seats in a particular section, price range, or other venue specific attribute, the goal is to come up was a set of seating swaps of allocated seats to make if possible to satisfy this new request.
Case 0: There are A adjacent seats available, allocate them according to some heuristic.
Case 1: A=2 and there are only singleton seats free.

Subcase 1a: Two empty singleton seats are in the same row. more everyone between the two empty seats to the left, resulting in two adjacent empty seats
Subcase 1b: If there is a singleton allocated seat adjacent to a singleton empty seat, swap the person in the singleton to with one of the two empty seats.
Case 2: A=3 Apply Case 1 to get two adjacent empty seats and then
Subcase 2a: A double empty and a single empty in same row, then shift all those in the middle
Subcase 2b: Find either a singleton adjacent to two empty seats or a double adjacent to one empty seat, and perform swap. General case, A seats. For all combinations of X, Y values where X+Y=A and recursively apply.

Options

In addition to or instead of digital tickets, systems according to the invention can be used to support the issuance and/or re-issuance of options for tickets, as well as the conversion of those options to tickets. In this regard, whereas tickets are typically tokens (and, specifically, in the case of embodiments discussed above, digital tokens) the ownership, holding and/or presentment of which can be a necessary (if not sufficient) condition for admission to and/or attendance at an event and/or seating therein, an option as used herein refers to token (again, here, digital) embodying a right to acquire a ticket for such admission/attendance and/or to gain such admission/attendance directly, usually upon payment of additional funds and/or meeting of other conditions. Like a ticket, an option may be for general admission or, more typically, for specific seating at a specific location or type of seating.

In the illustrated embodiment, an options (like a ticket) may be in any suitable digital form for transmission to, receipt by, display and/or processing on the digital data devices 10, 12, e.g., a text file, a PDF file, and so forth. Preferably, as above, the option is in a format, such as, PDF, that is suitable for digital signing or certification, e.g., in a manner conventional in the art as adapted in accord with the teachings hereof. Accordingly, the operations discussed above with respect to tickets can be performed with respect to options. This includes, by way of non-limiting example, the issuance, re-issuance and/or exchange of options in a manner paralleling that for digital tickets described above.

Thus, for example, the server can issue (and reissue) an option to a first digital data device and can reissue that same option (substantially identically or otherwise) to the second digital data devices; the server can obtain and/or maintain authenticating data concerning the digital data devices and/or their respective holders in connection with the issuance and/or reinsurance of options; the server can issue differing options to the first and second digital data devices vis-à-vis gaining the same aforesaid seating (or other selected attendance) at the event, and wherein those differences pertain to authenticating data issued with the respective options; the server can alter the option issued to the first digital data device in connection with issuing the option for the same aforesaid seating (or other selected attendance) to the second digital data device; the server can transfer the option from the first digital data device to the second digital data device in response to concurrent requests from the devices and particularly, for example, requests made by the holders of those devices; the server can effect a transfer of money or other thing of value to the holder of the first digital data device in connection with transfer of the option to the second digital data device; and so forth, all by way of example and all paralleling similar actions vis-a-vis tickets, as described above.

And, though the options of the illustrated embodiment are not intended for use as tickets per se, in some embodiments, they can be can be validated like digital tickets upon presentation by the holders of devices 10, 12 at the venue 22—though, typically, such holders must make additional payment at the time of such presentment and/or meet other conditions in order to take the “optioned” seating or admission.

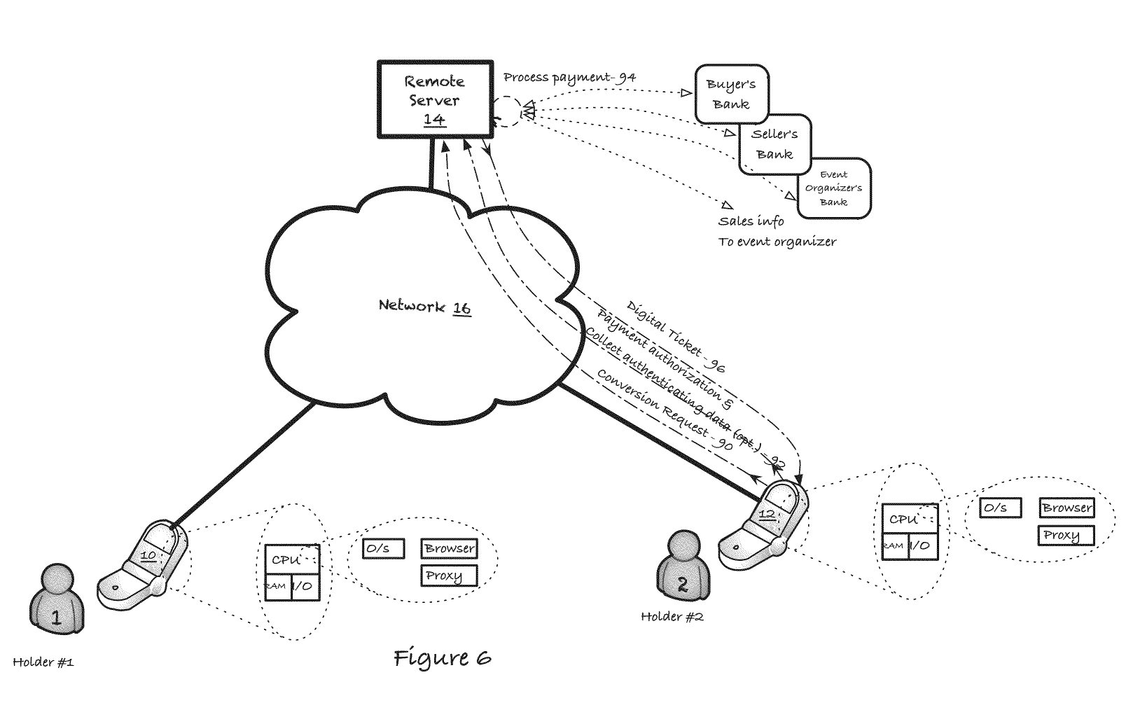

Thus, while options may be treated like tickets (and, hence, might be thought of as “tickets to buy tickets”), in the illustrated embodiment, the server 14 and digital data devices 10, 12 support additional processing for options—namely, conversion to tickets. This is illustrated in FIG. 6, depicting conversion of a valid option on device 12, way of example.

In step 90, digital data device 12 issues to server 14 a request for the ticket corresponding to an option previously issued to the holder of device 12. The request, which may be communicated a web page form(s) (e.g., via HTTP or otherwise), by special-purpose application or app, by e-mail or otherwise, may be made ad hoc, in connection with an auction (e.g., in concert with holders of other digital data devices who are also interested in conversion of like options) or otherwise, and it may specify a price or price range which the holder of device 12 is willing to pay for the ticket or an agreement (implicit or otherwise) to pay a price already set by the server 14 for such conversion.

In step 92, the server 14 seeks confirmation for the amount to be paid (if such authorization was not contained in the original request) and, optionally, verifying authorization data regarding the device 12 and/or the holder thereof (e.g., as discussed above). The server 14 than transfers funds between a bank account associated with the holder of device 12 and a bank associated with the event organizer, or otherwise. See step 94.

In connection therewith, in some embodiments of the server also transfers funds to a bank account associated with the event organizer or other third party. That transfer can be based, for example, on an amount paid for the ticket by the holder of device 12 and can be, for example, a fraction (such as, by way of non-limiting example, four percent) thereof. The server 14 can, instead or in addition, transmit a message to the event organizer (or other third party) indicating an amount paid by the holder device 12 for the ticket.

In some embodiments, the server 14 obtains payment from a party other than the holder of device 12. That third-party may be a contest organizer or otherwise. In such instances, the funds transfers of step 94 are exercised with respect to the bank of that third-party (not the bank of the holder of device 12). In step 96, the server 14 transmits the ticket to device 12 for the benefit of the holder thereof.

Systems of the type described above that permit issuance, re-issuance and/or conversion of options to tickets are advantageous to event organizers, holders of digital data devices and/or others. For example, they permit organizers to sell (and device holders to buy) options prior to the start of a sports season, an entertainment season or the like and, later, to convert those options to actual tickets, e.g., as the season develops, and when both organizers and device holders, alike, have an opportunity to determine the value of such conversion. Thus, for example, the owner of a new sports team could use such a system to sell options for seats at, say, $5 and, depending, how the team performs over the course of the season, permit device holders to convert those options to tickets for, say, $50 or $150, depending A producer of a play or musical could similarly use such a system to bring in funds from option purchasers, e.g., long before play or musical begins its run, and to allow option holders to convert them to tickets at a price dependent on the popularity of the play among reviewers.

Described above our systems and methods meeting the objects set forth previously. It will be appreciated that the embodiments discussed herein are merely examples of the invention and that other embodiments incorporating changes there to fall within the scope thereof.

Thus, by way of non-limiting example, it will be appreciated that the invention can be practiced with devices 10, 12 that are stationary (as well as those that are mobile). By way of further example, it will be appreciated that the functions of servers 14, 18 may be combined with one another (e.g., on a single device), may be divided among those devices differently that described above, may be distributed among still other devices, or otherwise.

By way of further example, it will be appreciated that systems according to the invention can be used, not only for the issuance and exchange of tickets for music, sporting and other entertainment events, but also for other ticketed events—such as raffles, lotteries, and a variety of other activities in which tickets are or might be uses.

By way of still further example, it will be appreciated that, although, the illustrated embodiments and examples discussed above show transfer of tickets (and options) from one digital data device (e.g., device 10) to another such device (e.g., device 12), as well as from the server 14 to such a digital data device (e.g., device 12), embodiments of the invention support chains of transfer, e.g., from one device to another and from that device to still another, and so forth.

In view of the foregoing, what is claimed is:

1. Digital ticketing system, comprising
A. a first digital data device,
B. a second digital data device,
C. a server digital data processor,
D. a network that is at least intermittently communicatively coupled with the first digital data device, the second digital data device and the server digital data processor to support communications between at least pairs thereof,
E. the server digital data processor exchanging between the first and second digital data devices tickets previously issued to those respective devices for use by the respective holder thereof in gaining the selected respective attendance at an even.

2-104. (canceled)

105. The digital ticketing system of claim 1, wherein the server digital data processor effects the exchange by transferring to the second digital data device a ticket previously issued to the first digital data device and transferring to the first digital data device a ticket previously issued to the second digital data device.

106. The digital ticketing system of claim 1, wherein the server digital data processor effects the exchange in response to concurrent requests by the holders of the first and second digital data devices.

107. The digital ticketing system of claim 106, wherein the concurrent requests comprise
a request by the holder of the first digital data device for acquisition of a ticket associated privileges of a type associated with the ticket previously issued to the second digital data device,
a request by the holder of the second digital data device for acquisition of a ticket associated privileges of a type associated with the ticket previously issued to the first digital data device.

108. The digital ticketing system of claim 106, wherein the holders of the first and second digital data devices are disposed in a venue of the event at a time of the concurrent requests.

109. The digital ticketing system of claim 106, wherein the concurrent requests are communicated to the server digital data processor from the first and second digital data devices on behalf of their respective holders.

110. The digital ticketing system of claim 1, wherein the server digital data processor transfers the ticket to the second digital data device in response in response to the holder of that device winning an auction for the ticket.

111. The digital ticketing system of claim 110, wherein the server digital data processor transfers the ticket to the second digital data device in response in response to the holder of that device winning an auction for the ticket.

112. The digital ticketing system of claim 111, wherein the server digital data processor mediates the auction as between (i) the holder of the first digital data device and (ii) plural other devices, including the second digital data device.

113. The digital ticketing system of claim 1, wherein the server digital data processor responds to a request by a holder of the second digital data device by notifying a holder of the first digital data device of a potential transfer of the ticket to the holder of the second digital data device.

114. The digital ticketing system of claim 1, wherein the server digital data processor responds to a request by a holder of the second digital data device by notifying holders of one or more digital data devices of a potential transfer of the ticket to the holder of the second digital data device.

115. The digital ticketing system of claim 114, wherein the server digital data processor responds to the request by notifying holders of one or more digital data devices of a potential transfer of the ticket to the holder of the second digital data device.

116. The digital ticketing system of claim 115, wherein the server digital data processor provides such notification via a badge, beacon, popup or other indicator that presents any of visually, audibly, tactually, vibrationally or otherwise on the one or more of each of the holders.

117. The digital ticketing system of claim 116, wherein the server digital data processor any of activates and deactivates any such badge, beacon, popup or other indicator depending on a status of the request.
